(19) United States
(12) Patent Application Publication
(10) Pub. No.: US 2008/0239926 A1
(43) Pub. Date: Oct. 2, 2008

(54) Optical Compensator, Optical Element, Optical Scanning Head An Optical Scanning Device

(75) Inventors: Teunis Willem Tukker, Eindhoven (NL); Joris Jan Vrehen, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 12/088,091

(22) PCT Filed: Sep. 15, 2006
(86) PCT No.: PCT/IB2006/053307

§ 371 Date: Mar. 26, 2008

(30) Foreign Application Priority Data
Sep. 26, 2005 (EP) 05108867.2

(51) Int. Cl. G11B 7/135

(52) U.S. Cl. 369/112.05

(57) ABSTRACT

An optical compensator for use in an optical scanning device for scanning a first optical record carrier (3′) having an information layer (2′) at a first information layer depth d and a second optical record carrier (3″) having an information layer (2″) at a second, different information layer depth d2. The scanning of the first and second optical record carrier is effected using a scanning spot (16) formed on the information layer by a first radiation beam having a first wavelength and a second radiation beam having a second, different wavelength respectively. The optical compensator includes a substantially circular phase structure having an annular zone arranged in the path of the first radiation beam and the second radiation beam. The annular zone is adapted for imparting a wavefront modification to said first radiation beam causing destructive interference over the area of the scanning spot (16) for radiation incident on said annular zone; and a wavefront modification to said second radiation beam for compensating spherical aberration. A further aspect of the present invention relates to an optical element for defining the numerical aperture of a radiation beam. The optical compensator or optical element can be used for a two- or three-wavelength system. The invention also discloses an optical scanning head, and an optical scanning device using the optical compensator. The invention also relates to an optical scanning head and an optical scanning device.

The present invention relates to an optical compensator or optical element for use in an optical scanning device for scanning optical record carriers having information layers, there being at least two different information layer depths within two different ones of the carriers.

The field of data storage using optical record carriers is currently an intensively researched area of technology. The optical record carriers exist in several formats, including compact discs (CD), conventional digital versatile discs (DVD), Blu-ray discs (BD) and high definition digital versatile discs (HDDVD). Within a format different types of record carrier are available, including read-only versions (e.g. CD-A, CD-ROM, DVD-ROM, BD-ROM), write-once versions (e.g. CD-R, DVD-R, BD-R) and re-writeable versions (e.g. CD-RW, DVDRW, BD-RE).

For scanning the different formats of optical record carrier it is necessary to use a radiation beam having a different wavelength. This wavelength is approximately 785 nm for scanning a CD, approximately 660 nm for scanning a DVD (note that the officially specified wavelength is 650 nm, but in practice it is often close to 660 nm) and approximately 405 nm for scanning a BD and HDDVD.

Different formats of optical record carrier are capable of storing different amounts of data. The maximum amount is related to the wavelength of the radiation beam with which the record carrier is scanned and a numerical aperture (NA) of the objective lens used for focusing the radiation beam on the disc. Scanning, when referred to herein, includes reading and/or writing and/or erasing of data on the record carrier.

The data on an optical record carrier is stored on an information layer. The information layer of the optical record carrier is protected by a cover layer which has a predetermined thickness. Different formats of optical record carrier have a different thickness of the cover layer, i.e. the protective layer covering the information layer on the side of the record carrier on which the radiation beam is incident. For example the cover layer thickness is: approximately 1.2 mm for CD; approximately 0.6 for DVD and HDDVD; and approximately 0.1 mm for BD.

When scanning an optical record carrier of a certain format, the radiation beam is focused to a scanning spot on the information layer. As the radiation beam passes through the cover layer of the optical record carrier spherical aberration is introduced into the radiation beam. The amount of introduced spherical aberration depends on the thickness of the cover layer and its refractive index, the wavelength of the radiation beam and its numerical aperture. To correct for this spherical aberration, the same amount of spherical aberration is introduced in the radiation beam prior to reaching the cover layer of the optical record carrier, so that it compensates the spherical aberration introduced by the cover layer. As a result, the radiation beam is substantially free from spherical aberration at the scanning spot focused on the information layer of the optical record carrier.

For scanning different optical record carriers with different cover layer thicknesses, the radiation beam needs to possess different amounts of spherical aberration prior to reaching the cover layer. This ensures the formation of a correct scanning spot on the information layer. As a consequence, when using a single objective lens to scan all optical record carriers, a different amount of spherical aberration for each optical record carrier type having a different cover layer must be generated by the system in order to cope with the difference in optical characteristics.

An article by B. H. W. Hendriks, J. E. de Vries, and H. P. Urbach entitled “Application of non-periodic phase structures in optical systems”, Applied Optics vol. 40, pp 6548-6560 (2001) describes a nonperiodic phase structure (NPS) which is capable of rendering an objective lens designed for scanning a DVD record carrier compatible with scanning a CD record carrier.

A two-mode objective lens such as a DVD/CD compatible lens can be realized by combining a lens optimized for one mode with an NPS or a diffractive structure which corrects the spherical aberration in the other mode. In the case of a three mode objective lens the demands for such an NPS or diffractive structure are very severe since the structure has to compensate different amounts of spherical aberration in two modes, while leaving the third mode unaffected.

A drawback of many currently proposed solutions is that they rely on gratings diffracting in a different order for each wavelength. This imposes a relation between the amounts of the aberration that need correction and the wavelengths. For example, a BD objective lens system can be made compatible with DVD and CD by using respectively the zeroth, first and second order diffraction of a grating. This would be a feasible solution if the amount of aberration introduced for CD has the same shape and appropriately twice the magnitude as for DVD. Since this is not exactly true for this system for the given wavelengths and cover layer thicknesses, another small correction must be added.

For a HDDVD triple mode objective lens this is even more difficult, since the difference in OPD between HDDVD and DVD which needs to be corrected is very small compared to the difference in OPD between DVD and CD or between HDDVD and CD which needs to be corrected.

International patent application WO 03/060892 describes an optical scanning device for scanning an information layer of two or three different optical record carriers using two or three different radiation beams. Each radiation beam has a polarization and a wavelength. The device includes an objective lens and a non-periodic phase structure (NPS) for compensating a wavefront aberration of one or two of the radiation beams. The phase structure includes birefringent material and has a non-periodic stepped profile. The phase structure introduces two different amounts of spherical aberration into respective radiation beams depending on the type of record carrier being scanned. However, this is done by the use of birefringement materials, which means that the phase structure is relatively expensive to manufacture.

A record carrier having a higher information density requires a smaller diameter scanning spot to read the information. The diameter of the scanning spot for a certain wavelength which is focused on the optical record carrier is proportional to the wavelength divided by the numerical aperture. Therefore, record carriers having a higher information density are designed for shorter wavelengths and higher numerical apertures. In a three wavelength system it is desirable to increase the numerical aperture successively for the shorter two of the three wavelengths, so that the size of the scanning spot is appropriately reduced for the respective optical record carriers.

In prior-art systems the numerical aperture for the longer wavelengths is typically limited by a dichroic plate having two coatings, suitably arranged in concentric rings and disposed in the optical path. These coatings selectively transmit different wavelengths, and can be arranged to provide three different numerical apertures for the three different wavelengths. For example, the coatings can be arranged so that the radiation having the shortest wavelength is transmitted over the entire aperture of the plate, giving a numerical aperture determined by the diameter of the plate, or by a mechanical aperture placed elsewhere in the optical path.

One coating, disposed in an outer annular region, or ring, of the plate can be arranged to prevent passage of radiation of the intermediate and longest wavelength, thus limiting the numerical aperture for the radiation of the intermediate wavelength. The other coating, disposed over an inner annular region of the plate can be arranged to prevent passage of radiation of the longest wavelength, further limiting the numerical aperture for the radiation of the longest wavelength.

Publication IEEE Transactions on Consumer Electronics Vol 44 no 3 August 1998, pages 591 to 600 (Yamada et al) discloses a two-wavelength device for scanning CDs and DVDs, limiting the numerical aperture for the radiation of the longer wavelength (for scanning CDs). The document discloses a holographic optical element (HOE) provided with an inner section formed as a hologram lens and an outer section formed as a diffraction grating having a phase structure in the form of straight steps, i.e. not curved or elliptical.

Radiation of the shorter wavelength incident on the HOE is transmitted without diffraction in both the inner and outer section as a parallel beam which is used for forming a scanning spot on a DVD. This is achieved by selecting the height of the steps in the hologram and the grating such that they cause phase steps of an integer number times 2π in the radiation of the shorter wavelength. Radiation of the longer wavelength incident on the hologram is diffracted preferentially in a first order transmitted diverging beam for focusing to a scanning spot on a CD. Radiation of the longer wavelength incident on the grating is diffracted preferentially in first order transmitted beams that do not focus on the scanning spot. As a result, the numerical aperture of the beam forming the longer wavelength scanning spot is determined by the size of the hologram in the inner section. The spherical aberration compensating for the difference in thickness of the cover layer between CD and DVD is generated using the so-called finite conjugate method.

WO 02/29798 discloses a phase structure adapted for use in an optical scanning device in which a detector detects two radiation beams having different wavelengths. The phase structure changes the shape of the wavefront of one of the radiation beams so as to cause a discontinuity in the gradient of the wavefront. This prevents the wavefront outside the discontinuity from reaching the detector, and limits the numerical aperture of the radiation beam incident on the detector. The discontinuity is effected by providing the phase structure with steps having sloping surfaces. These sloping surfaces impart a changing wavefront modification across the area of the top of the step. However, it is difficult to manufacture such sloping steps.

Where the term “step” is used herein it should be taken to mean two adjacent vertical walls and the surface between them, where a “wall” is a vertical surface, and “vertical” means substantially parallel to the optical axis and/or substantially parallel to the local direction of propagation of the radiation beam. The surface of a step is at a different height from neighboring surfaces; this height is referred to as the “height difference” between neighboring steps. Furthermore, a “step height” is hereby defined as the distance between a point on the step and the base of the structure on which the step is formed. The term “neighboring step” refers to a step next to another step (i.e. two steps sharing a vertical wall), and the term “neighboring surface”, refers to respective surfaces of neighboring steps. A “nearby” step is defined herein as a step in the vicinity of another step; a nearby step includes, but need not be a neighboring step. The “width” of a step is defined as the extent of the step in the radial direction of the cross-section of the radiation beam.

It is an object of the present invention to provide a less expensive optical compensator which generates the required amount of spherical aberration for different wavelengths and which defines the required numerical aperture for different wavelengths, without using the finite conjugate method.

In accordance with one aspect of the present invention, there is provided an optical compensator for use in an optical scanning device for scanning a first optical record carrier having an information layer at a first information layer depth d, and a second optical record carrier having an information layer at a second, different information layer depth d₂, using a scanning spot formed on the information layer by a first radiation beam having a first wavelength and a second radiation beam having a second, different wavelength respectively, the optical compensator including a substantially circular phase structure having an annular zone arranged in the path of the first radiation beam and the second radiation beam; wherein said annular zone is adapted for imparting: a wavefront modification to said first radiation beam causing destructive interference over the area of the scanning spot for radiation incident on said annular zone; and a wavefront modification to said second radiation beam for compensating spherical aberration.

The invention provides a way of allowing an optical scanning device to scan record carriers of at least two different types, requiring different wavelengths, using the same optical system. The annular zone of the optical compensator prevents radiation of the first radiation beam from reaching the area of the scanning spot (i.e. the area within the first dark ring of the Airy pattern of the scanning spot), thereby determining the numerical aperture for the first radiation beam.

This means that a scanning spot of the correct size is formed on the record carrier being read. The optical compensator modifies the wavefront of the second radiation beam; the optical compensator is therefore able to correct the spherical aberration in the second radiation beam, so that the scanning spot of the second radiation beam is correctly formed. This means that the second record carrier can be read or written to. The cost of the optical compensator according to the invention is relatively low, because it does not require the use of birefringent material. Furthermore, the phase structure of embodiments of the present invention may have sloping steps, for example, in the case where it is integrated with the objective lens. However, the phase structure can be constructed using flat steps, i.e. ones which are substantially perpendicular to the local direction of propagation of the radiation beam.

The optical compensator may be further adapted for scanning a third optical record carrier having an information layer at a third information layer depth d₃, said scanning using a third radiation beam, wherein said annular zone is adapted for imparting a substantially zero wavefront modification to said third radiation beam.

Thus, the optical compensator may allow an optical scanning device to scan record carriers of three different types, requiring different wavelengths and numerical apertures, using the same optical system. The annular zone is substantially invisible to the third radiation beam.

The optical compensator may comprise a further annular zone around the annular zone, the further annular zone may be adapted for providing: a wavefront modification to said first radiation beam such that the wavefront modification to said first radiation beam causing destructive interference over the area of the scanning spot for radiation incident on said further annular zone; and a substantially zero wavefront modification to said third radiation beam.

Thus, the further annular zone of the optical compensator assists in defining the numerical aperture of the first radiation beam by preventing the radiation from the first radiation beam which passes through the further annular zone of the optical record carrier from reaching the position of the scanning spot. The further annular zone does not affect the third radiation beam, so the further annular zone of the optical device is substantially invisible to this beam. Thus, the numerical aperture of the third radiation beam is not reduced.

The further annular zone may be adapted for providing: a wavefront modification to said second radiation beam causing destructive interference over the area of the scanning spot for radiation incident on said further annular zone.

Thus, the further annular zone of the optical device further limits the numerical aperture of the second radiation beam, by preventing the radiation from the second radiation beam which passes through the further annular zone of the optical record carrier from reaching the position of the scanning spot.

The further annular zone of the optical compensator may comprise a plurality of steps, and the difference in height of each of the steps may give rise to phase steps equal to an integer number times the wavelength of the third radiation beam.

Thus, the steps are invisible to the third radiation beam since no phase difference, i.e. a phase difference of 2πn, where n is an integer number, is introduced into the third radiation beam by the steps.

The annular zone of the optical compensator may comprise a plurality of steps, and the difference in height of each of the steps may give rise to phase steps equal to an integer number times the wavelength of the third radiation beam. Thus, the steps are invisible to the third radiation beam since no phase difference is introduced into the third radiation beam by the steps.

The heights of the steps may be chosen so that the phase difference between the portions of the first radiation beam passing through nearby steps is approximately π.

Thus, portions of the first radiation beam passing through neighboring steps will undergo destructive interference in the second and/or further annular zones. This reduces the numerical aperture associated with the first radiation beam.

Less than 20% of the first radiation beam passing through said annular zone and/or said further annular zone may reach the area within the first dark ring of the scanning spot. This allows a good cancellation of the first radiation beam when the radiation beam is brought to the focus. The cancellation can be optimized by choosing the width of the phase steps.

The nearby steps may be adapted for introducing a substantially constant phase change into the second radiation beam.

This allows the surface area of steps introducing a phase change of π into the wavefront, and the surface area of steps introducing a substantially zero phase difference into the wavefront of the first radiation beam, to be made roughly equal, so that the transmission efficiency of the annular zone for the first radiation beam reaching the inner area of the Airy pattern of the scanning spot is 20% or less. The inner area is the area within the first dark ring of the Airy pattern of the scanning spot pertaining to the first radiation beam. The first radiation beam may be diffracted by the further annular zone of the optical compensator, and wherein the intensity of the first radiation beam is substantially zero at the zeroth order maxima of the optical compensator.

This allows the radiation of the non zeroth orders of the first radiation beam to be diffracted away from the focus, whereas the wavefront of the zeroth order optical compensator is cancelled out.

In accordance with a second aspect of the present invention there is provided an optical compensator for use in an optical scanning device for scanning a first optical record carrier using a scanning spot formed by a radiation beam; the optical compensator including a phase structure having an annular zone and arranged in the radiation beam, wherein said annular zone is adapted for imparting a wavefront modification to said first radiation beam causing destructive interference over the area of the scanning spot for radiation incident on said annular zone, wherein said annular zone comprises non-periodic phase steps.

This means that the annular zone can impart a desired amount of wavefront modification over the annular zone, by placing steps in appropriate positions in the annular zone. The non-periodicity reduces the diffraction effects of the phase structure in the annular zone, smearing out the radiation and reducing the formation of areas around the scanning spot having a high intensity of radiation. Such areas of high intensity may affect the reading of the information.

In accordance with a third aspect of the present invention there is provided an optical element for defining the numerical aperture of a radiation beam for use in an optical scanning device for scanning a first or second optical record carrier, said scanning being effected with a first or second radiation beam respectively, said optical element comprising an annular zone having an inner radius and an outer radius, wherein said inner radius of said annular zone defines a numerical aperture for said first radiation beam, and in that said outer radius of said annular zone is smaller than the cross section of said first radiation beam at said optical element.

Thus, this aspect of the invention provides an optical element which limits the numerical aperture of the first radiation beam and in which the cross section of the wavefront of the first radiation beam is larger than the outer radius of the annular zone. The numerical aperture is limited in this way because the slope of the wavefront of the first radiation beam is such that the radiation passing outside the annular zone does not fall within the area of the scanning spot. The second radiation beam incident on the optical element also has a cross section larger than the outer radius of the annular zone. The radiation of this beam passes through the phase structure to the scanning spot. The part of the radiation incident outside the annular zone also passes to the scanning spot without passing through the phase structure, and therefore the transparency of the optical element is increased, reducing the loss of radiation.

The optical element may comprise a further annular zone, around said annular zone, said further annular zone having an inner radius and an outer radius, wherein said inner radius of said further annular zone defines a numerical aperture for said second radiation beam, and wherein said outer radius of said further annular zone is smaller than the cross section of said second radiation beam at said optical element.

Thus, this the invention provides an optical element which limits the numerical aperture of the second radiation beam and in which the cross section of the wavefront of the second radiation beam is larger than the outer radius of the further annular zone. The numerical aperture is limited in this way because the slope of the wavefront of the second radiation beam is such that the radiation passing outside the annular zone does not fall within the area enclosed by the first dark ring of the Airy pattern of the scanning spot.

If this compensator is used in a three-wavelength optical scanning device, where a third radiation beam is used for scanning a third optical record carrier, the part of the third radiation beam incident outside the further annular zone does not pass through the phase structure of the optical compensator, and therefore the transparency of the optical system in which the optical element is used is increased, so that there is less loss of radiation.

In accordance with a fourth aspect of the present invention there is provided an optical compensator for use in an optical scanning device for scanning a first optical record carrier and a second optical record carrier, the optical compensator including a phase structure arranged in the path of the first radiation beam and the second radiation beam, wherein said phase structure is adapted for providing: a first numerical aperture for said first radiation beam; a second, different numerical aperture for said second radiation beam, said first and second numerical apertures being defined by phase changes introduced by the phase structure into a wavefront of the first radiation beam, and of phase changes introduced by the phase structure into a wavefront of the second radiation beam.

Thus, the optical compensator provides a way of limiting the numerical aperture of the first and second radiation beams by introducing phase changes into the respective wavefronts, without the use of dichroic materials.

For example, an optical compensator for use with DVD and BD, or DVD and CD, or CD and HDDVD may be provided according to the present invention.

Furthermore, said optical compensator may limit the numerical aperture of the first and second radiation beams in an optical scanning device which can scan three different types of optical record carriers, using three radiation beams respectively. Hence, a system which can scan BD, DVD and CD, or alternatively HDDVD, DVD and CD may be provided. In these systems the numerical aperture of the radiation beam for scanning DVD and CD or for scanning BD (or HDDVD), DVD and CD may be defined by the optical compensator.

In accordance with a fifth aspect of the present invention there is provided an optical element for use in an optical scanning device for scanning a first optical record carrier having an information layer at a first information layer depth d, and a second optical record carrier having an information layer at a second, different information layer depth d₂, using a scanning spot formed on the information layer by a first radiation beam having a first wavelength and a second radiation beam having a second, different wavelength respectively, the optical element including a central zone through which the first and second radiation beams are arranged to pass to said scanning spot, the optical element further including an annular zone having a substantially circular phase structure, arranged around the central zone and in the path of the first radiation beam and the second radiation beam; wherein that said annular zone is adapted for imparting a wavefront modification to said first radiation beam causing destructive interference over the area of the scanning spot for radiation incident on said annular zone, and wherein said annular zone passes said second radiation beam to said scanning spot.

In the annular zone the first radiation beam is subject to destructive interference, and the second radiation beam passes through the annular zone to the scanning spot. The known phase structure disclosed in the Yamada document mentioned above, in the form of a grating having straight steps, cannot be used for introducing a rotationally symmetric aberration such as defocus or spherical aberration in the second radiation beam.

An optical scanning head, comprising the optical scanning compensator above may be provided. The use of the compensator according to the invention avoids the need for a numerical-aperture-defining element in the optical head, thereby simplifying the construction and reducing the cost of the optical head.

An optical scanning device including an optical compensator above may be provided.

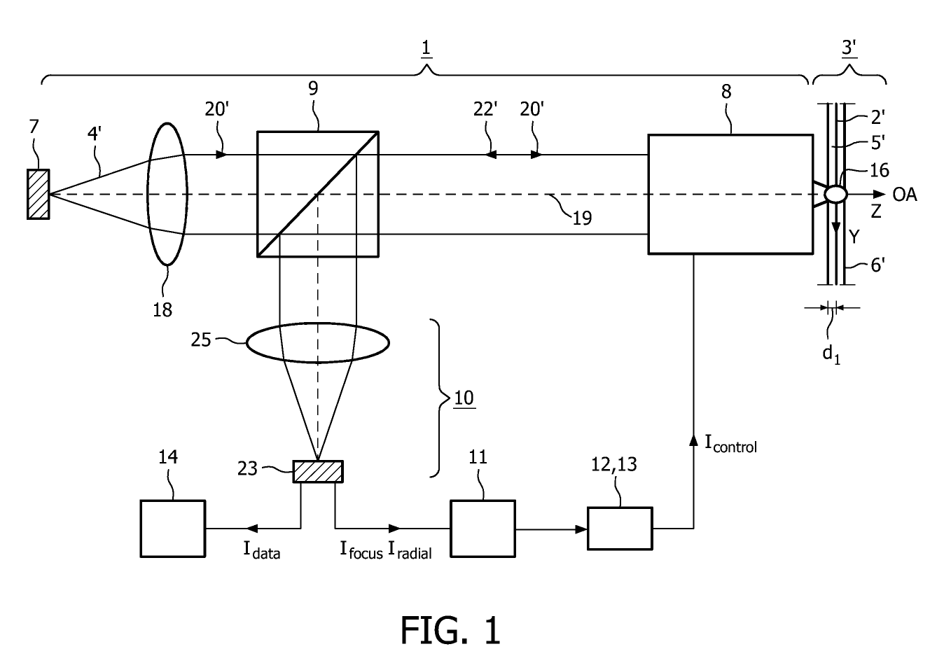

FIG. 1 shows schematically an optical scanning device in accordance with an embodiment of the invention;

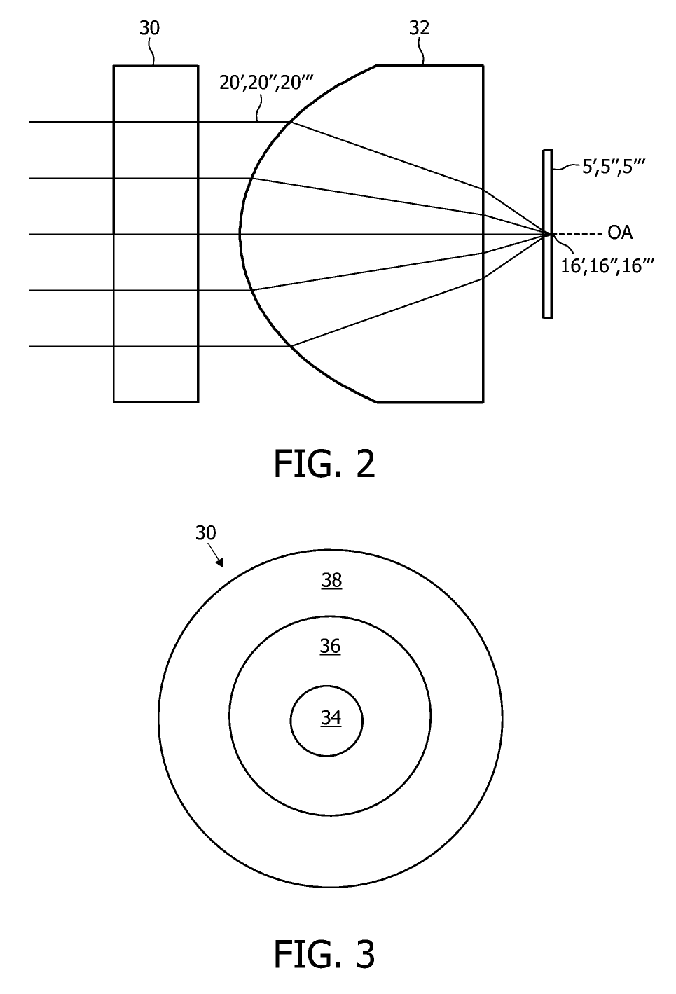

FIG. 2 shows schematically an optical system of the optical scanning device in accordance with an embodiment of the invention;

FIG. 3 shows schematically a plan view of an optical compensator in accordance with an embodiment of the invention;

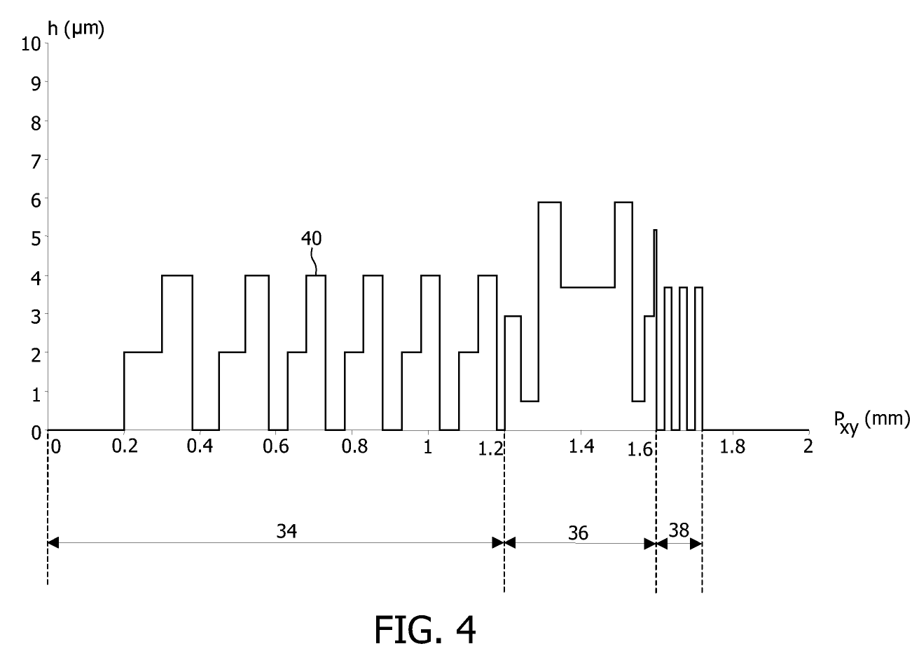

FIG. 4 is a graph showing the profile of the optical compensator of FIG. 3;

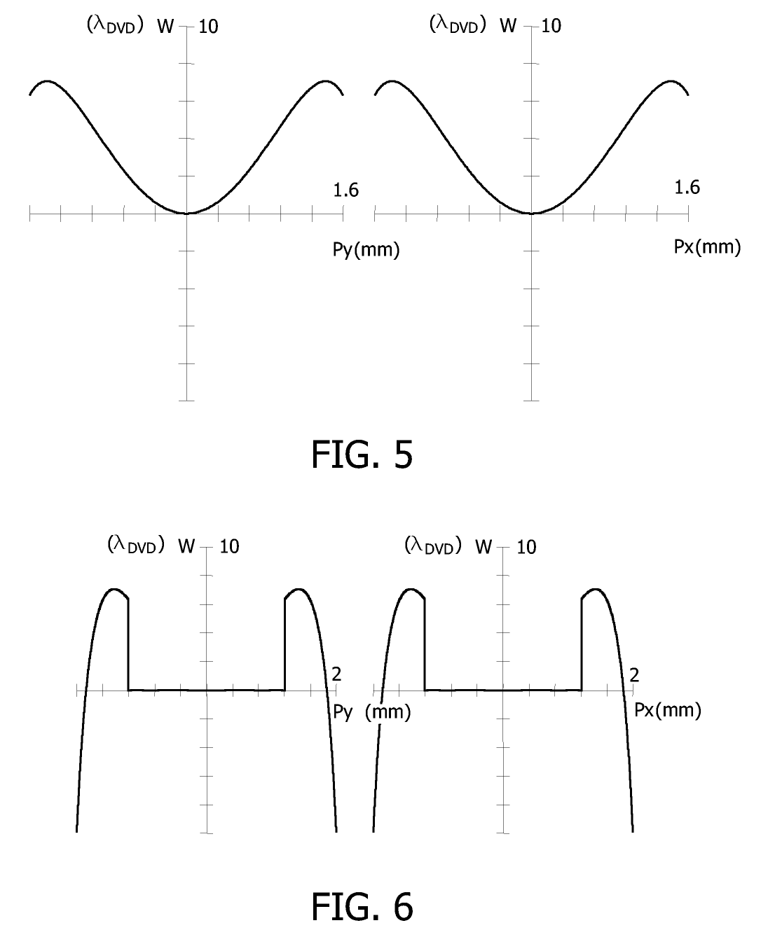

FIG. 5 is a graph showing a wavefront aberration for a second radiation beam over the first and second zones of an optical compensator, prior to correction in the first zone;

FIG. 6 is a graph showing a wavefront aberration for a second radiation beam over an optical compensator, prior to correction in a second zone;

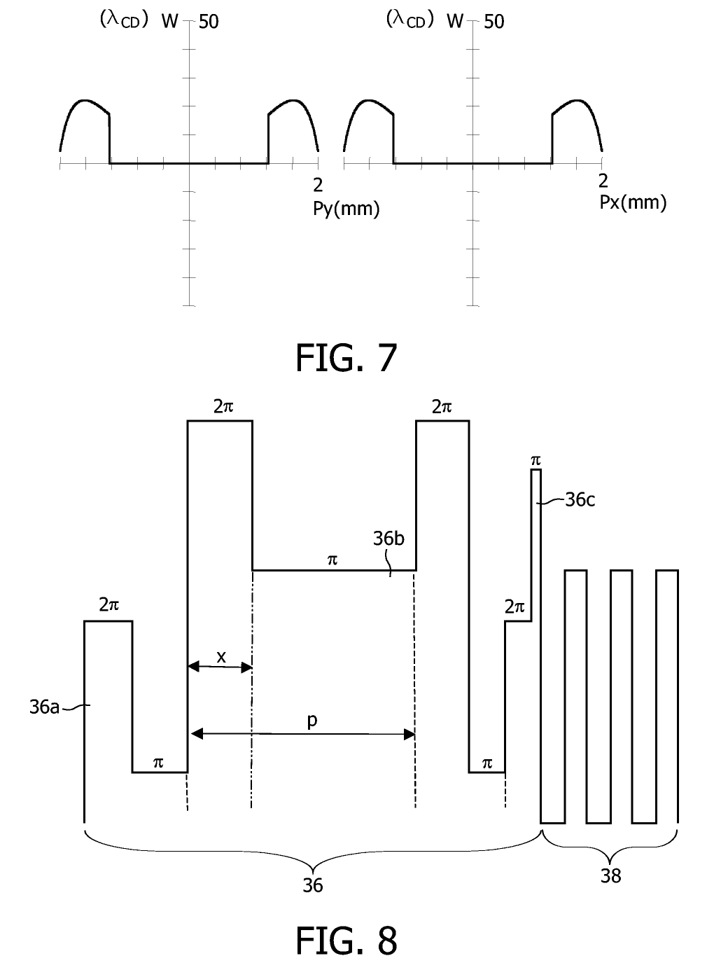

FIG. 7 is a graph showing a wavefront aberration for a first radiation beam over an optical compensator, prior to correction in a second zone;

FIG. 8 shows the second and third zones of the optical compensator shown in FIG. 4;

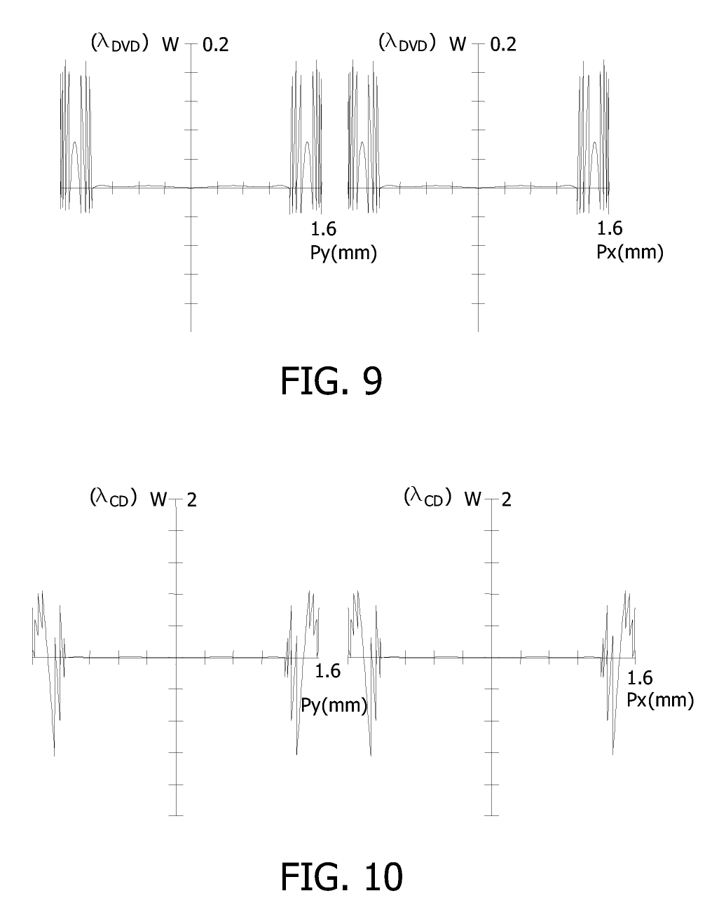

FIG. 9 is a graph showing a wavefront aberration for a second radiation beam over the first and second zones of an optical compensator, after correction in a second zone;

FIG. 10 is a graph showing a wavefront aberration for a first radiation beam over the first and second zones of an optical compensator, after correction in a second zone;

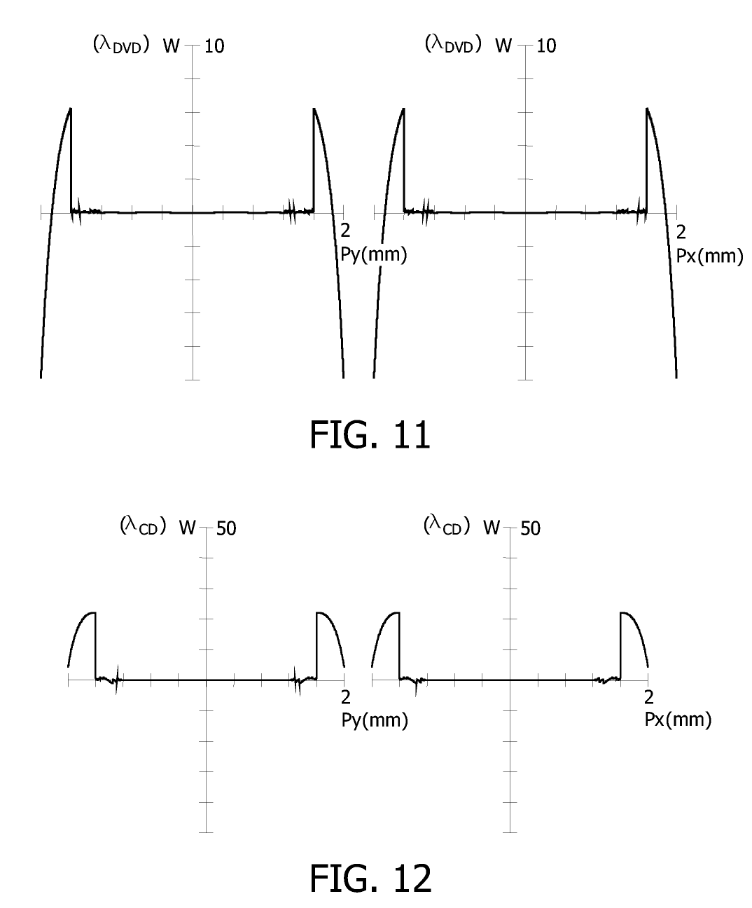

FIG. 11 is a graph showing a wavefront aberration for a second radiation beam over an optical compensator, prior to correction in a third zone;

FIG. 12 is a graph showing a wavefront aberration for a first radiation beam over an optical compensator, prior to correction in a third zone;

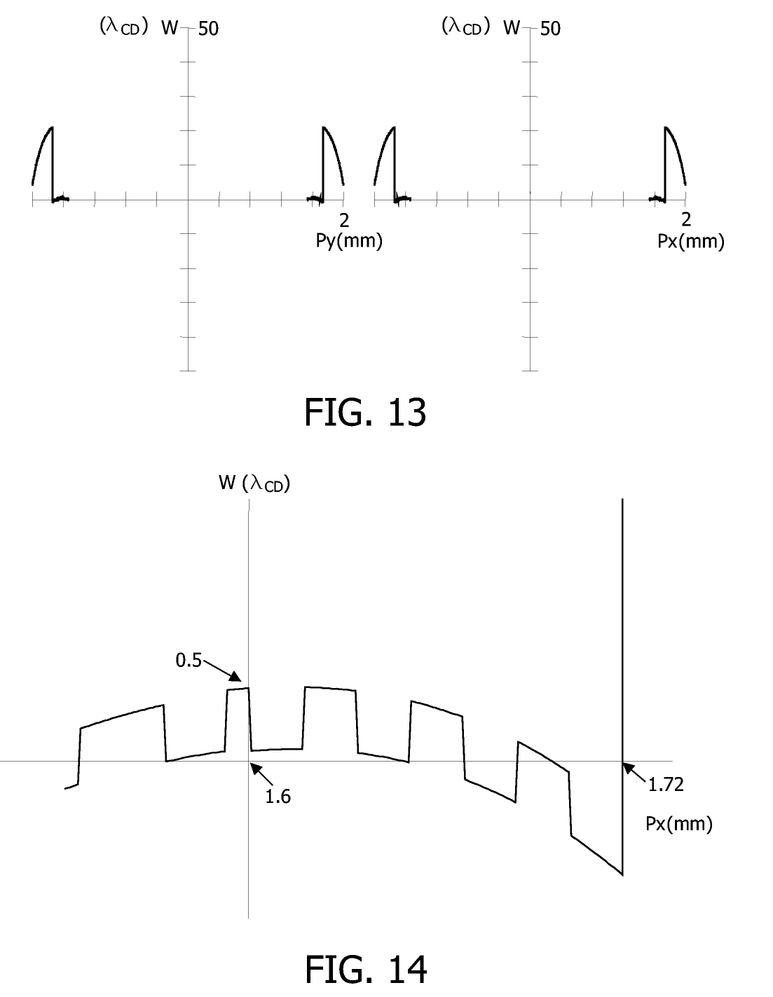

FIG. 13 is a graph showing a wavefront aberration for a first radiation beam over an optical compensator, after correction in a third zone; and

FIG. 14 is a graph showing a magnified image of the wavefront aberration of FIG. 13.

FIG. 1 shows schematically an optical scanning device for scanning first, second and third optical record carriers with a first, second and third, different, radiation beam, respectively. The first optical record carrier 3′ is drawn in the Figure and has a first information layer 2′ which is scanned by means of the first radiation beam 4′. The first optical record carrier 3′ includes a cover layer 5′ on one side of which the first information layer 2 ′ is arranged. The side of the information layer facing away from the cover layer 5′ is protected from environmental influences by a protective layer 6′. The cover layer 5′ acts as a substrate for the first optical record carrier 3′ by providing mechanical support for the first information layer 2′.

Alternatively, the cover layer 5′ may have the sole function of protecting the first information layer 2′, while the mechanical support is provided by a layer on the other side of the first information layer 2′, for instance by the protective layer 6′ or by an additional information layer and cover layer connected to the uppermost information layer.

The first information layer 2′ has a first information layer depth d₁ that corresponds to the thickness of the cover layer 5′. The second and third optical record carriers (not shown) have a second and a third, different, information layer depth d₂, d₃, respectively, corresponding to the thickness of the cover layer (not shown) of the second and third optical record carriers, respectively. The third information layer depth d₃ is less than the second information layer depth d₂ which is less than the first information layer depth d₁, i.e. d3<d2<d1.

The first information layer 2′ is a surface of the first optical record carrier 3′. Similarly the second and third information layers (not shown) are surfaces of the second and third optical record carriers respectively. Where the term “depth” is referred to herein, it should be taken to include the refractive index of the cover layer, i.e. it is not limited to the physical depth of the carrier layer. The optical compensator may be arranged for use with both DVD and HDDVD. In both of these optical record carriers the physical thickness of the cover layer is 0.6 mm, and the desired numerical aperture of both is 0.65. However, different wavelengths are used for scanning DVD and HDDVD. Depending on the objective lens used the radiation beams for scanning HDDVD and DVD may need different spherical aberration corrections because of the different wavelengths.

Each information layer of the optical record carriers contain at least one track, i.e. a path to be followed by the scanning spot of a focused radiation on which path optically-readable marks are arranged to represent information. The marks may be, e.g., in the form of pits or areas with a reflection coefficient or a direction of magnetization different from the surroundings. In the case where the first optical record carrier 3′ has the shape of a disc, the following is defined with respect to a given track: the “radial direction” is the direction of a reference axis, the X-axis (perpendicular to the page in FIG. 1), between the track and the center of the disc and the “tangential direction” is the direction of another axis, the Y-axis, that is tangential to the track, perpendicular to the X-axis and in the information plane. The Z-axis is perpendicular to the information plane. In this embodiment the first optical record carrier 3′ is a compact disc (CD) and the first information layer depth d₁ is approximately 1.2 mm, the second optical record carrier is a conventional digital versatile disc (DVD) and the second information layer depth d₂ is approximately 0.6 mm, and the third optical record carrier is a Blu-ray™ disc (BD) and the third information layer depth d₃ is approximately 0.1 mm.

As shown in FIG. 1, the optical scanning device 1 has an optical axis OA and includes a radiation source system 7, a collimator lens 18, a beam splitter 9, an objective lens system 8 and a detection system 10. Furthermore, the optical scanning device 1 includes a servo circuit 11, a focus actuator 12, a radial actuator 13, and an information processing unit 14 for error correction.

The radiation source system 7 is arranged for consecutively or simultaneously producing the first radiation beam 4′, the second radiation beam and/or the third, different, radiation beam (not shown in FIG. 1). For example, the radiation source 7 may comprise either a tuneable semiconductor laser for consecutively supplying the radiation beams or three semiconductor lasers for simultaneously or consecutively supplying these radiation beams. The first radiation beam 4′ has a first predetermined wavelength λ₁ the second radiation beam 4″ has a second, different, predetermined wavelength λ₂, and the third radiation beam 4′″ has a third different predetermined wavelength λ₃. In this embodiment the third wavelength λ₃ is shorter than the second wavelength λ₂. The second wavelength λ₂ is shorter than the first wavelength λ₁.

In this embodiment the first, second and third wavelength λ₁, λ₂, λ₃, respectively, is within the range of approximately 770 to 810 nm for λ₁, 640 to 680 nm for λ₂, 400 to 420 nm for λ₃ and preferably approximately 785 nm, 660 nm and 405 nm, respectively. These wavelengths can be used for scanning CD, DVD and BD respectively. The present invention is not limited to the choice of these wavelengths or record carrier systems. However, the difference between the different wavelengths should be at least 20 nm, and more preferably should be approximately 50 nm.

The collimator lens 18 is arranged on the optical axis OA for transforming the first radiation beam 4′ into a first substantially collimated beam 20′. Similarly, it transforms the second and third radiation beams into a second substantially collimated beam 20″ and a third substantially collimated beam 20′″.

The beam splitter 9 is arranged for transmitting the first, second and third collimated radiation beams toward the objective lens system 8. Preferably, the beam splitter 9 is a plane parallel plate tilted with an angle a with respect to the optical axis OA and, preferably, α=45°.

The objective lens system 8 focuses the first, second and third collimated radiation beams to a desired focal point on the first, second and third optical record carriers, respectively. The desired focal point for the first radiation beam is a first scanning spot 16′. The desired focal point for the second and third radiation beams are second and third scanning spots 16″, 16′″, respectively (shown in FIG. 2). Each scanning spot corresponds to a position on the information layer of the appropriate optical record carrier. Each scanning spot is preferably substantially diffraction limited and has an rms wavefront aberration which is less than 70 mλ to allow proper scanning of the information layer.

During scanning, the first optical record carrier 3′ rotates on a spindle (not shown) and the first information layer 2′ is then scanned through the cover layer 5′. The focused first radiation beam 20′ reflects on the first information layer 2′, thereby forming a reflected first radiation beam which returns on the optical path of the forward converging focused first radiation beam provided by the objective lens system 8. The objective lens system 8 transforms the reflected first radiation beam to a reflected collimated first radiation beam 22′. The beam splitter 9 separates the forward first radiation beam 20′ from the reflected first radiation beam 22′ by transmitting at least a part of the reflected first radiation beam 22′ towards the detection system 10.

The detection system 10 includes a converging lens 25 and a quadrant detector 23 which are arranged for capturing said part of the reflected first radiation beam 22′ and converting it to one or more electrical signals. One of the signals is an information signal I_{data}, the value of which represents the information scanned on the information layer 2′. The information signal I_{data} is processed by the information processing unit 14 for error correction. Other signals from the detection system 10 are a focus error signal I_{focus} and a radial tracking error signal I_{radial}. The signal I_{focus} represents the axial difference in height along the optical axis OA between the first scanning spot 16′ and the position of the first information layer 2′. Preferably, this signal is formed by the “astigmatic method” which is known from, inter alia, the book by G. Bouwhuis, J. Braat, A. Huijser et al, entitled “Principles of Optical Disc Systems,” pp. 75-80 (Adam Hilger 1985 ISBN 0-85274-785-3). A device for creating astigmatism in the radiation beam incident on the detection system according to this focusing method is not illustrated. The radial tracking error signal I_{radial} represents the distance in the plane of the first information layer 2′ between the first scanning spot 16′ and the center line of a track in the information layer 2′ to be followed by the first scanning spot 16′. Preferably, this signal is formed by the “radial push-pull method” which is known from, inter alia, the book by G. Bouwhuis, pp. 70-73.

A servo circuit 11 provides, in response to the signals I_{focus} and I_{radial}, servo control signals I_{control} for controlling the focus actuator 12 and the radial actuator 13, respectively. The focus actuator 12 controls the position of a lens of the objective lens system 8 along the optical axis OA, thereby controlling the position of the first scanning spot 16′ such that it coincides substantially with the plane of the first information layer 2′. The radial actuator 13 controls the position of the lens of the objective lens system 8 along the X-axis, thereby controlling the radial position of the first scanning spot 16′ such that it coincides substantially with the center line of the track to be followed in the first information layer 2′.

FIG. 2 shows schematically the objective lens system 8 of the optical scanning device. The objective lens system 8, in accordance with an embodiment of the present invention, is arranged to introduce first and second, different, wavefront modifications WM₁, WM₂ into at least part of the first and second radiation beams 20′, 20″, respectively.

The objective lens system 8 includes an optical compensator or optical element, and an objective lens 32 which are both arranged on the optical axis OA. The objective lens 32 has an aspherical face facing in a direction away from the optical record carrier. The lens 32 is, in this example, formed of glass. The lens may be designed as an infinite conjugate lens.

The optical compensator in this embodiment is in the form of a corrector plate 30 having a phase structure. The corrector plate 30 includes a planar base substrate on which a phase structure including a series of annular zones is formed.

FIG. 3 shows a schematic plan view of the phase structure 30. The phase structure comprises a first zone 34, a second, annular zone 36, and a third, further annular zone 38. The first zone 34 is adapted for introducing a correction to compensate for spherical aberration in the first and second radiation beam (for example, for scanning CD and DVD respectively), whilst not affecting the wavefront of the third radiation beam (for example, for scanning BD). The second zone 36 is adapted for causing the first radiation beam to undergo destructive interference, so that the intensity at the focus of the optical scanning device of the first radiation beam which has passed through the second zone is low. The second zone also introduces a required spherical aberration correction into the second radiation beam, and is substantially invisible to the third radiation beam. The third zone 38 is adapted for causing the first radiation beam to undergo destructive interference, again so that the intensity at the focus of the optical scanning device of the first radiation beam which has passed through the third zone is low, and is not used for scanning the record carrier. The third zone 38 is arranged so that the portion of the second radiation beam which passes through the third zone 38 is not brought to a focus in the optical scanning device. Again, the third zone 38 is substantially invisible to the third radiation beam.

Thus, the phase structure 30 provides an optical element which defines a different numerical aperture for each of the three radiation beams. Only the portion of the first wavelength beam which passes through the first zone 34 of the phase structure is used to read the optical record carrier, and therefore the diameter of the cross section of the radiation beam at the position of the compensator for the first radiation beam, having a wavelength of λ₁ corresponds to the diameter of the first zone, namely 1.2 mm in the example discussed above. Systems having different objective lenses may have different values for the beam diameter, and the zones of the optical compensator may be required to have different dimensions.

Further, only the portion of the second wavelength beam which passes through the first and second zones 34, 36 of the phase structure is used to read the disc, and therefore the diameter of the cross section of the radiation beam at the position of the compensator for the second wavelength beam corresponds to the outer diameter of the second zone, namely 1.6 mm. The first, second and third zones 34, 36, 38 of the phase structure are invisible to the third radiation beam, and therefore the compensator does not reduce the cross section of the third radiation beam. This may give a numerical aperture of 0.85 for the third radiation beam, for example. The numerical aperture for the second and first radiation beams may be 0.65 and 0.5 respectively. The phase structure limits the numerical apertures of the respective radiation beams even when the object of the incident radiation beams is at the conjugate of the lens (for example, at infinity). The location where the NA is defined is preferably at the position of the pupil. Hence, for scanning CD and DVD the NA-defining phase structure is preferably located at the pupil position, and for scanning BD the phase structure or some other mechanical aperture in the radiation path can be located at the pupil position

Thus the phase structure limits the numerical aperture of the first and second radiation beams, which results in a larger scanning spot at the focus of the respective beams, whilst introducing the desired amount of correction into the first and second radiation beams, which leads to better quality of the scanning spot. The second and third zones of the phase structure do not affect the third radiation beam; this is not needed since the objective lens 32 is optimized for the third radiation beam in this example. The phase structure shown in FIG. 3 is substantially circular. Where the term “circular” is used herein it should be taken to include substantially elliptical, i.e. designed for a radiation beam of elliptical cross section. The optical compensator can be superposed on the objective lens, or can be formed as a separate optical structure.

FIG. 4 shows a graph of the phase structure of FIG. 3 in profile. It shows that the first, second and third zones 34, 36, 38 are made up of a number of steps 40 of different heights. In the first zone 34 the heights of the steps 40 are shown purely schematically; the numbers on the ordinate are only representative of the step heights in the second and third zones and do not represent the step heights used in the first zone. The first zone is designed to correct for spherical aberration in the first and second radiation beam. This may be effected in a number of ways described in the applicant's earlier European patent application with number 04106462.7, attorney's docket number PHNL041388EPP. In this document a non-periodic phase structure (NPS) is disclosed, for use with a BD-optimized objective lens. Since the objective lens is optimized for BD it is necessary to compensate at least some of the remaining OPD for DVD and CD over the part of the NPS used for the three wavelengths, i.e. over the first zone in the present invention. In order to correct the remaining OPDs for the DVD and the CD mode a series of NPS zones are provided, having steps superposed on an aspherical surface. The steps compensate at least some of the remaining OPD for DVD and CD but also add a small amount of aberration to the BD mode. In this case (optimized lens for BD) the step heights are within ranges:

$$h = m * {h}_{BD} + \frac{Δ * {λ}_{BD}}{{n}_{BD} - 1} , where - 0.4 < Δ < 0.4 \qquad ( 1 )$$

An additional radial surface profile is used in each zone, which is generated using a merit function. The best local zone height is determined for each radial position separately. To achieve this, the local zone height is varied and for each local zone height the merit function is determined.

The local zone height with the lowest merit has the highest quality and is chosen as best local zone height for that radius. The quality for a wavelength (CD, DVD or BD) is high when the remaining OPD at the scanning spot is close to zero. The merit function takes into account the quality for each wavelength, and balances the qualities to provide the highest overall quality as measured by the merit function. The remaining OPD (ROPD) is calculated by subtracting the OPD due to the zone height from the OPD that must be corrected and taking a fractional part of this value, so that all remaining OPDs lie between −0.5 wave and +0.5 wave.

An example of a merit function which may be used is the following:

Merit=(W_{BD}*ROPD_{BD}⁴)+(W_{DVD}*ROPD_{DVD}⁴)+(W_{CD}*ROPD_{CD}⁴) (2)

In equation (2), ROPD_{BD}, ROPD_{DVD} and ROPD_{CD} are the remaining OPDs for the different modes of operation. They are raised to a given even and positive power, in this example the 4^{th} power, in order to ensure that a high remaining OPD at one wavelength is much worse than a low remaining OPD at the other wavelengths in terms of radiation loss in the structure. With the weighting factors Wₓₓ the contribution of each mode can be weighted in dependence on the requirements of the modes.

The merit function selects an optimum solution so that the RMS remaining OPDs for each wavelength, or at least two of the wavelengths, are preferably less than 0.5 wave, more preferably less than 0.4 and even more preferably less than 0.333 wave.

Alternatively, the first zone may be as described in the applicant's earlier European patent application with number 04101208.9 and applicant's earlier International patent application with number IB2005/050918, attorney's docket number PHNL041388EPP and PHNL041388WO, respectively. In this document a phase structure is disclosed for use with a DVD-optimized objective lens. A grating is superposed on an aspherical surface of an optical compensator. The −1^{st} order (m₃) of the grating is used to correct spherical aberration in BD radiation, and the 1^{st} order of the grating is used to correct spherical aberration in the CD radiation (m₁), and the zeroth order is used for the DVD radiation (m₂). The position of the diffraction orders are such that the following condition holds:

$$- 1 < \frac{( {m}_{3} - {m}_{2} )}{( {m}_{2} - {m}_{1} )} - \frac{( {d}_{3} - {d}_{2} )}{( {d}_{2} - {d}_{1} )} < 1$$

Turning back to the present invention the heights of the steps 40 in the second and third zones are represented graphically in FIG. 4, and are calculated below. The step heights are chosen so as to introduce substantially no optical path difference in the third radiation beam, and are calculated using equation (3) below:

$${h}_{BD} = i \frac{{λ}_{BD}}{{n}_{BD} - 1} \qquad ( 3 )$$

In this equation i is an integer, λ_{BD} is the wavelength of the third radiation beam (used for scanning Blu-ray discs, in this example) and n_{BD} is the refractive index for λ_{BD} of the material from which the phase structure is made. When the phase structure interfaces with a different material, the denominator becomes the difference of the refractive index of this material and n_{BD}. Thus, the zone heights differ by integral multiples (1, 2, 3, etc.) of a basic step height. The corresponding phase changes introduced into the first and second radiation beams are then calculated using the following equations:

$$\begin{matrix}{ϕ}_{DVD} = \frac{{h}_{BD} ( {n}_{DVD} - 1 )}{{λ}_{DVD}} & ( 4 ) \\ {ϕ}_{CD} = \frac{{h}_{BD} ( {n}_{CD} - 1 )}{{λ}_{CD}} & ( 5 )\end{matrix}$$

The results of these calculations for 1≦i≦10 is shown in the following table:

TABLE 1

| i | h_{BD} [micron] | φ_{DVD} modulo 2π | φ_{CD} modulo 2π |
|---|---|---|---|
| 1 | 0.000 | 0.000 | 0.000 |
| 2 | 0.736 | 0.602 | 0.495 |
| 3 | 1.473 | 0.204 | 0.990 |
| 4 | 2.209 | 0.806 | 0.485 |
| 5 | 2.946 | 0.407 | 0.980 |
| 6 | 3.682 | 0.009 | 0.475 |
| 7 | 4.419 | 0.611 | 0.970 |
| 8 | 5.155 | 0.213 | 0.465 |
| 9 | 5.892 | 0.815 | 0.960 |
| 10 | 6.628 | 0.417 | 0.455 |

The heights of the steps 40 in the second and third zones shown in FIG. 4 are selected from the list of calculated values of h_{BD} given above. The step heights from this list which are used in the second zone 36 are then chosen according to the amount of OPD they introduce into the second radiation beam (DVD). Therefore, the spherical aberration in the second beam can be compensated by choice of the step heights and choice of the distance between the steps, so that the desired amount of OPD is introduced into the second radiation beam over the second zone.

FIG. 5 shows the OPD for the second radiation beam along the X-axes and along the Y-axes without any correction over the first or second zones of the optical element, essentially showing the spherical aberration which must be corrected by the optical element. The first zone ends at a radius of 1.2 mm, and the second zone ends at a radius of 1.6 mm.

FIG. 6 shows the remaining OPD for the second radiation beam, after correction in the first zone, such as in the manner discussed above, but without correction in the second and third zones. As can be seen from the graph, the OPD of the second radiation beam rises sharply at a radius of 1.2 mm, corresponding to the start of the second zone, where no correction has been effected.

FIG. 7 shows the remaining OPD for the first radiation beam, without correction by the phase structure in the second and third zones. As can be seen from this graph the OPD of the first radiation beam rises sharply at a radius of 1.2 mm, corresponding to the start of the second zone.

As mentioned above, in connection with FIG. 3 the properties of the second zone are twofold: First the modulo 2π of the OPD of the second radiation beam to should be reduced to approximately zero. To effect this, step heights from Table 1 are chosen that reduce the phase difference by the required amount at the required radial position P_{x,y}.

Secondly, the compensation applied to the wavefront of the first radiation beam in the second zone should cause the portion of the first radiation beam passing through this zone of the phase structure to undergo destructive interference, so that this portion of the first radiation beam does not contribute to the scanning spot. In order to achieve this it is necessary to choose the step heights in the second zone so that roughly equal amounts of the first radiation beam are given (modulo 2π) phase changes of substantially 0 and π (or π and 2π), so that radiation from nearby steps will interfere destructively in the second zone.

Alternatively, the difference in the OPD between portions of the first radiation beam passing through nearby steps may be made to be equal to π to effect the destructive interference. Therefore, the step heights must be selected so that they fulfill both of the functions stated above, i.e. so that the OPD of the second radiation beam is reduced to approximately zero and so that the first radiation beam undergoes destructive interference. Furthermore, in the case where the compensator is used with a third radiation beam the step heights should also be selected so that the steps are substantially invisible to the third radiation beam.

In order to calculate the required step heights in this example the graph of FIG. 6 will again be considered. From the graph of FIG. 6, it can be determined that a phase change of approximately 0.4λ_{DVD} should be introduced into the second radiation beam at the beginning of the second zone, at P_{x,y}=1.2 mm, so that the radiation passing through this portion of the second zone is brought to the focus, and has the correct phase.

Therefore, from Table 1, it can be seen that a step height of either 2.946 μm or 6.628 μm could be used. According to Table 1 these step heights introduce a phase difference of approximately 2π and π into the first radiation beam respectively. It can be seen from Table 1 that the ten different step heights shown give five substantially different phase changes for the second radiation beam, and each of the five phase changes has a corresponding pair of phase changes for the first radiation beam, giving a phase change of 2π or π for the first radiation beam. Therefore, the step heights and positions across the second zone can be chosen to introduce the desired amount of correction into the second radiation beam, whilst ensuring that neighboring or nearby steps give an overall canceling effect to the first radiation beam across the zone, by virtue of the phases introduced into the first radiation beam by the steps.

The chosen step heights (which are shown in FIG. 4) across the second zone, together with the amount of phase change introduced are shown in Table 2:

TABLE 2

| rᵢₙ [mm] | height [μm] | φ_{DVD} modulo 2π | φ_{CD} modulo 2π |
|---|---|---|---|
| 1.201 | 2.946 | 0.407 | 0.980 |
| 1.243 | 0.736 | 0.602 | 0.495 |
| 1.290 | 5.892 | 0.815 | 0.960 |
| 1.348 | 3.682 | 0.009 | 0.475 |
| 1.490 | 5.892 | 0.815 | 0.960 |
| 1.536 | 0.736 | 0.602 | 0.495 |
| 1.568 | 2.946 | 0.407 | 0.980 |
| 1.592 | 5.155 | 0.213 | 0.465 |

As can be seen from Table 2 and from FIG. 4 the widths of the steps are irregular, i.e. the widths of the steps are not the same, and there is no periodicity in the widths of the steps. This means that the second zone causes substantially no diffraction effects. Furthermore, the widths of the steps are not such that the phase structure has an overall converging or diverging effect on the incident radiation beam. Such an effect would be obtained if the widths of the steps varied across the phase structure such that the widths successively increased or decreased by a predetermined factor, i.e. the structure has an increasing or decreasing period.

FIG. 8 shows the second and third zones from FIG. 4, stating the phases modulo 2π which the steps in the second zone introduce into the first radiation beam. The zones are made up of pairs of steps, the steps in each pair giving a phase change of 2π and π respectively. The width of a pair of neighboring steps is given as p, and the position of the boundary between the steps in the pair is shown as x. In an ideal phase structure x is exactly half the value of p, indicating that approximately equal areas of the phase structure introduce a π phase change and a 2π phase change; this approximation holds for small, thin rings. If the areas are approximately equal, all of the radiation passing through this zone of the optical element will undergo destructive interference, and the efficiency of the phase structure at the zeroth order (i.e. at the focus of the optical device) will be about 0%. As the values of the phase structure deviate from the ideal, the efficiency of the phase structure at the zeroth order increases with a quadratic dependency (to a first-order approximation). The values for the power at the zeroth order for x/p=0.7 to 0.3 for steps which give a modulo 2π phase height of 0.5 wave (π phase) are given in the following table:

TABLE 3

| | Phase height | Power in zeroth |
|---|---|---|
| x/p | [waves] | order [%] |
| 0.70 | 0.5 | 16 |
| 0.65 | 0.5 | 9 |
| 0.60 | 0.5 | 4 |
| 0.55 | 0.5 | 1 |
| 0.50 | 0.5 | 0 |
| 0.45 | 0.5 | 1 |
| 0.40 | 0.5 | 4 |
| 0.35 | 0.5 | 9 |
| 0.30 | 0.5 | 16 |

In embodiments of this invention a power in the zeroth order below 20% is acceptable, but a power below 10% is preferred. The above discussion related to a pair of neighboring steps. However, it is not necessary for the steps to be neighboring; the above discussion applies if the steps in question are merely nearby, such as for example, steps 36a and 36b; or 36a and 36c.

The value of x/p for the steps indicated in FIG. 8 will now be calculated. In this example the value of x is 0.058 mm, and the value of p is 0.200 mm. This means that the value of x/p is 0.29. In order the reduce the efficiency at the scanning spot of the radiation passing through these steps the step 36b could be split into two steps, so that the value of x/p for the three steps together is brought as close as possible to 0.50. For example, the step 36b (having a width of 0.142 mm and height of 3.682 μm) could be replaced with two steps, both of which give the same desired phase change for the second radiation beam, in this case a phase change of zero, and which give a phase change of π in the first radiation beam. The step 36b could be split up into a first step having a width of 0.100 mm and a height of 3.682 μm and the second having a width of 0.042 mm and a height of 0 μm. The entire zone may have an arbitrary, possibly slowly varying or constant phase offset for the first radiation beam.

FIG. 9 shows the remaining OPD for the second radiation beam in the first and second zones after correction in the second zone, using the step heights and positions shown in table 2 above. As can be seen from FIG. 9 the remaining OPD over the second zone is less than 0.2λ_{DVD}. FIG. 10 shows the remaining OPD for the first radiation beam in the first and second zones after correction in the second zone. The amplitude of the remaining OPD in the second zone has a high spatial frequency phase variation, and the peak-to-peak amplitude is very high. Thus, rays of the first radiation beam near to each other on the wavefront will have significantly different phases, and will interfere with each other. This interference is such that the radiation of the first wavelength passing through the second zone of the optical compensator will not form part of the scanning spot, thereby providing the desired definition of the numerical aperture of the first radiation beam.

If the height of the steps of the phase structure are such that an unacceptable power of the first radiation beam from the second zone is present at the focus of the optical device it is possible to alter the height of some of the steps to reduce the power. For example, one of the steps could be split into two steps, both of which give substantially the same phase change to the second radiation beam, but which give canceling phase changes to the first radiation beam (such as π and 0). In this way, the power at the focus of the first radiation beam can be reduced, whilst maintaining the correction effect for the second radiation beam.

Next, a consideration of the corrections introduced in the third zone of the phase structure will be made. FIG. 11 shows the remaining OPD of the second radiation beam prior to correction in the third zone. As can be seen from the Figure the phase sharply increases at a radius of 1.6 mm, corresponding to the beginning of the third zone of the phase structure. The small variation seen in FIG. 9 remaining in the second zone of the phase structure can also be seen on this graph. It can be seen in this graph that the gradient of the curve is such that none of the second radiation beam which has passed through the third zone of the phase structure is brought to a focus (since the gradient of the graph is not flat over any part of the third zone). This effect is due to an amount of de-focus which has been introduced to the first radiation beam in the objective lens in this particular example. Therefore it is not necessary to compensate for the OPD of the second radiation beam in this zone, since it is already dispersed, and does not affect the quality of the scanning spot.

FIG. 12 shows the remaining OPD of the first radiation beam prior to correction in the third zone. Again, the phase sharply rises at 1.6 mm, corresponding to the beginning of the third zone (where no correction has yet been made). It can also be seen from this graph that the wavefront is roughly flat between 1.6 and approximately 1.72 mm (gradient of the phase substantially equal to zero), indicating that this radiation will proceed towards the scanning spot, if no correction is effected. It is therefore necessary to add phase changes to the first radiation beam over the third zone, so that the beam destructively interferes with itself, to prevent the radiation with the flat wavefront from reaching the scanning spot, thereby reducing the numerical aperture.

As before, this is done by choosing step heights which introduce no phase change to the third radiation beam, but which introduce the desired amount of phase change to the first radiation beam. Since there is no requirement to alter the phase of the second radiation beam in the third zone the step heights of every other step can be the same for ease of manufacture, and the spacing between the step heights can be uniform so that the value of x/p can be close to 0.5, to give optimum cancellation and ease of manufacture. However, the wavefront of the second radiation beam should not be altered so that the radiation passing through the third zone reaches the scanning spot. Such an embodiment of the phase structure in the third zone is effectively a diffraction grating; this contrasts to the part of the phase structure in the second zone, which is not necessarily periodic, and is non-periodic in the example disclosed herein.

An example of values of the step heights in the third zone can be seen in the following table:

TABLE 4

| rᵢₙ [mm] | height [μm] | φ_{CD} modulo 2π |
|---|---|---|
| 1.600 | 0.000 | 0.000 |
| 1.620 | 3.682 | 0.475 |
| 1.640 | 0.000 | 0.000 |
| 1.660 | 3.682 | 0.475 |
| 1.68 | 0.000 | 0.000 |
| 1.70 | 3.682 | 0.475 |
| 1.72 | 0.000 | 0.000 |

As can be seen, the third zone gives a 0 or π phase change to portions of the first radiation beam passing through successive steps of the third zone of the phase structure. Thus, the first radiation beam cancels itself out in the third zone.

Since, in this example, the structure of the third zone is effectively a truncated diffraction grating, diffuse diffraction orders are generated. The zeroth order diffraction beam is not present in this grating, due to the fact that the first radiation beam has undergone destructive interference, and therefore there is no radiation proceeding to the scanning spot.

FIG. 13 shows the remaining OPD for the first radiation beam after correction in the third zone. The phase sharply increases at a radius of 1.72 mm, which corresponds to the end of the phase structure. It is possible to end the phase structure on the optical compensator here because there is no requirement to alter the phase of radiation at radial points beyond this; it can be seen from the gradient of the graph of FIG. 12 that the wavefront of the first wavelength where P_{x,y}>1.72 mm does not travel towards the focusing spot. It is advantageous to arrange for the phase structure to be shortened in this manner because this reduces the difficulty of manufacture of the optical compensator. Furthermore, there is no phase structure for the radiation of the third wavelength to pass through where P_{x,y}>1.72 mm, and this eliminates any possible small changes to the wavefront that the phase structure would otherwise introduce. Thus, by omitting the phase structure after P_{x,y}>1.72 mm the quality of the scanning of the third optical record carrier may be improved. FIG. 14 shows a section of the graph of FIG. 13 for the second and third zones magnified.

In an alternative configuration, where it is necessary to correct the second radiation beam in the third zone the correction is effected in the same way as the correction of the first and second radiation beams in the second zone, by choosing step heights which introduce the desired amount of phase difference into the second radiation beam, whilst ensuring that the portions of the first radiation beam passing through nearby or neighboring steps cancel themselves out. In this case the phase structure may be non-periodic over the second and third zones, and no diffraction effects will occur. A non-periodic structure has sudden changes in the pitch of the steps; it has no gradual changes in the pitch of the steps, such as occur in a diffraction grating imparting defocus or spherical aberration to the radiation beam.

If necessary, a further, fourth zone outside the third zone can be added to the phase structure. This could be useful, for example to define the numerical aperture for BD instead of using a mechanical aperture in the radiation path.

After correction it is desirable that the maximum peak-to-peak remaining OPDs for the second radiation beam is as small as possible. Preferably the peak-to-peak value of the remaining OPD is less than 0.58, more preferably less than 0.48 wave and even more preferably less than 0.3338 or 0.28 wave. However, there remain higher order aberrations.

The above embodiments are to be understood as illustrative examples of the invention. Further embodiments of the invention are envisaged. For example, whilst the calculations above have been made for a wavelength for scanning Blu-ray, DVD and CD discs it is possible to use the present invention for any wavelength, or combination of different wavelengths of radiation beams. It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

1. An optical compensator for use in an optical scanning device for scanning a first optical record carrier having an information layer at a first information layer depth d₁ and a second optical record carrier having an information layer at a second, different information layer depth d₂, using a scanning spot formed on the information layer by a first radiation beam having a first wavelength and a second radiation beam having a second, different wavelength respectively,
the optical compensator including a substantially circular phase structure having an annular zone arranged in the path of the first radiation beam and the second radiation beam; characterized in that said annular zone is adapted for imparting:
a wavefront modification to said first radiation beam causing destructive interference over the area of the scanning spot for radiation incident on said annular zone; and
a wavefront modification to said second radiation beam for compensating spherical aberration.

2. An optical compensator as claimed in claim 1, wherein the optical compensator is further adapted for scanning a third optical record carrier having an information layer at a third information layer depth d₃, said scanning using a third radiation beam, wherein said annular zone is adapted for imparting a substantially zero wavefront modification to said third radiation beam.

3. An optical compensator as claimed in claim 2, wherein the optical compensator comprises a further annular zone around the annular zone, said further annular zone being adapted for providing:
a wavefront modification to said first radiation beam such that the wavefront modification to said first radiation beam causing destructive interference over the area of the scanning spot for radiation incident on said further annular zone; and
a substantially zero wavefront modification to said third radiation beam.

4. An optical compensator as claimed in claim 3, wherein said further annular zone is adapted for providing:
a wavefront modification to said second radiation beam causing destructive interference over the area of the scanning spot for radiation incident on said further annular zone.

5. An optical compensator as claimed in claim 3, wherein said further annular zone comprises a plurality of steps, and wherein the difference in height of each of the steps gives rise to phase steps equal to an integer number times the wavelength of the third radiation beam.

6. An optical compensator as claimed in claim 1, wherein said annular zone comprises a plurality of steps, and wherein the difference in height of each of the steps gives rise to phase steps equal to an integer number times the wavelength of the third radiation beam.

7. An optical compensator as claimed in claim 5, wherein the heights of the steps are chosen so that the phase difference between the portions of the first radiation beam passing through nearby steps is substantially π.

8. An optical compensator as claimed in claim 7, wherein less than 20% of the first radiation beam passing through said annular zone and/or said further annular zone reaches the area of the scanning spot.

9. An optical compensator as claimed in claim 7, wherein said nearby steps are adapted for introducing a substantially constant phase change into the second radiation beam.

10. An optical compensator as claimed in claim 3, wherein the first radiation beam is diffracted by the further annular zone of the optical compensator, and wherein the intensity of the first radiation beam is substantially zero over the area of the scanning spot.

11. An optical compensator for use in an optical scanning device for scanning a first optical record carrier using a scanning spot formed by a radiation beam;
the optical compensator including a phase structure having an annular zone and arranged in the radiation beam, wherein said annular zone is adapted for imparting a wavefront modification to said first radiation beam causing destructive interference over the area of the scanning spot for radiation incident on said annular zone;
characterized in that said annular zone comprises non-periodic phase steps.

12. An optical element for defining the numerical aperture of a radiation beam for use in an optical scanning device for scanning a first or second optical record carrier, said scanning being effected with a first or second radiation beam respectively, said optical element comprising an annular zone having an inner radius and an outer radius,
characterized in that said inner radius of said annular zone defines a numerical aperture for said first radiation beam, and in that said outer radius of said annular zone is smaller than the cross section of said first radiation beam at said optical element.

13. An optical element as claimed in claim 12 comprising a further annular zone, around said annular zone, said further annular zone having an inner radius and an outer radius, wherein said inner radius of said further annular zone defines a numerical aperture for said second radiation beam, and wherein said outer radius of said further annular zone is smaller than the cross section of said second radiation beam at said optical element.

14. An optical compensator for use in an optical scanning device for scanning a first optical record carrier and a second optical record carrier, the optical compensator including a phase structure arranged in the path of the first radiation beam and the second radiation beam, characterized in that said phase structure is adapted for providing:
a first numerical aperture for said first radiation beam;
a second, different numerical aperture for said second radiation beam, said first and second numerical apertures being defined by phase changes introduced by the phase structure into a wavefront of the first radiation beam, and of phase changes introduced by the phase structure into a wavefront of the second radiation beam.

15. An optical scanning head, comprising the optical scanning compensator as claimed in claim 1.

16. An optical scanning device including an optical head as claimed in claim 15.
